(19) United States
(12) Patent Application Publication
(10) Pub. No.: US 2011/0126497 A1
(43) Pub. Date: Jun. 2, 2011

(54) METHOD FOR THE PRODUCTION OF A BIODEGRADABLE PLASTIC FILM, AND FILM

(75) Inventors: Michael Bauer, Forchheim (DE); Karl Mauser, Leutenbach (DE); Roland Kelm, Forchheim (DE); Kurt Stark, Neuhaus/Peg (DE)

(73) Assignee: HUHTAMAKI FORCHHEIM ZWEIGNIEDERLASSUNG DER HUHTAMAKI DEUTSCHLAND GMBH & CO, FORCHHEIM (DE)

(21) Appl. No.: 12/301,910

(22) PCT Filed: May 15, 2007
(86) PCT No.: PCT/EP2007/054729

§ 371 Date: Jun. 10, 2010

(30) Foreign Application Priority Data
May 23, 2006 (DE) 10 2006 024 568.7

(51) Int. Cl. B65B 11/00; B29C 47/00; B29C 47/06; B32B 37/12; B29C 51/00; B32B 27/36; B32B 27/06; C08L 29/04

(52) U.S. Cl. 53/461; 264/176.1; 264/171.13; 156/244.11; 264/173.16; 264/331.11; 428/480; 525/56; 525/60; 525/57

(57) ABSTRACT

A method for producing a biodegradable plastic film or a composite film, and the film obtained by such method. The film has barrier properties and is made at least of a biodegradable basic plastic material and a second plastic material having barrier properties. The film is useful in particular for packaging sensitive goods.

This invention concerns a method of producing a biodegradable plastic film or film assembly having barrier properties and also the film produced by this method.

A multiplicity of biodegradable plastic films are known from the prior art, but they all have the disadvantage of limited suitability for packaging sensitive goods.

Films and film assemblies are also known from the prior art that have barrier properties and therefore are particularly useful for packaging articles sensitive to oxygen for example. These films and film assemblies, however, are not biodegradable, or are only obtainable in very costly and inconvenient, multi-step processes.

It is an object of the present invention to provide a method and a plastic film or film assembly which is biodegradable and has good barrier properties with regard to oxygen for example.

We have found that this object is achieved according to the present invention when the film or film assembly is produced at least from a biodegradable base plastic material and a second plastic material having barrier properties.

This combines good barrier properties with biodegradability.

It is also very advantageous when the plastic materials are mixed before extrusion and then extruded together.

This firmly integrates the barrier properties into the base plastic material.

It has also proven very advantageous, in a further embodiment of the present invention, when the plastic materials are mixed together before extrusion to form a masterbatch and are then extruded together with further base material.

This makes it possible to achieve better mixing.

In a further very advantageous embodiment of the present invention, the plastic materials are each extruded as film plies and conjoined.

It is very advantageous here when the plastic materials are jointly coextruded.

This likewise provides a very good barrier effect. The cost of producing the layers is appreciably reduced by the joint coextrusion of the layers.

It has also proven very advantageous when the extruded film plies are finished with an adhesion promoter and conjoined with further film plies to form a multi-layered assembly.

The use of an adhesion promoter appreciably improves the inter-ply connectivity.

It is also very advantageous when the plastic film or the multilayered assembly is oriented.

This reduces layer thickness. In addition, especially strength, splittability and also the barrier properties can be altered and/or improved by orienting.

It has also proven very advantageous according to the present invention when a stabilizer is added to the masterbatch or mixture.

This prevents unwanted separation, or inhomogeneities in the mixture.

In a further very advantageous embodiment of the present invention, an adhesion promoter is added to the masterbatch or mixture.

The admixed adhesion promoter can ensure a more stable mixture of the different, often incompatible plastic materials and improved bonding to further layers.

But it is also very advantageous when an adhesion promoter is introduced between two film plies in each case.

The adhesion promoter may be coextruded together with at least one of the two film plies.

But it is also very advantageous according to the present invention when the adhesion promoter is applied, in particular extruded, onto one of the film plies.

This makes it possible for the adhesion promoter to be applied specifically and possibly not even uniformly.

It is also a very advantageous embodiment of the method according to the present invention when the base plastic material is admixed with a further plastic material to enhance the compatibility with the barrier material.

This makes it possible for actually incompatible plastic materials to be bonded together compatibly.

It has also proven extremely advantageous when the base plastic material is mixed with a portion of the barrier material.

It is likewise a very advantageous development of the present invention when the barrier material is admixed with a further plastic material to enhance the compatibility with the base material.

It is extremely advantageous here when the barrier material is mixed with a portion of the base plastic material.

This appreciably improves the compatibility of the barrier material with further plastic layers.

It has also proven very advantageous according to the present invention when the final film is heat molded, in particular thermoformed.

As a result, the film according to the present invention has extremely diverse uses.

It is also extremely advantageous when a biodegradable barrier material is used.

As a result, the biodegradability of the entire film is not impaired.

It has proven very advantageous for a biodegradable plastic film obtained by the method according to the present invention when a PLA is provided as base plastic material.

It is also very advantageous according to the present invention when a polyvinyl alcohol (PVOH) is provided as additional plastic material.

Polyvinyl alcohols have proven to be very good barrier materials. To modify plastic materials, however, it is also very useful to use PVOH.

It has proven extremely advantageous in this context when a modified PVOH is provided.

As a result, the already very good properties can be still further improved.

A further very advantageous embodiment of the present invention is also present when an ethylene-containing vinyl alcohol (EVOH) is provided as additional plastic material.

EVOH has still further improved properties.

It has also proven very advantageous in this connection when a modified EVOH is provided.

Modified EVOHs are particularly efficient to bond to other plastic materials.

It has also proven extremely advantageous in accordance with a further embodiment of the present invention when a further additive material having barrier properties, in particular a biodegradable additive material is provided.

This means that the biodegradability of the entire film construction is not adversely affected.

In a further very advantageous embodiment of the present invention, a blend of PVOH, modified PVOH, EVOH, modified EVOH and/or further additive materials is provided for producing the biodegradable plastic film.

This provides very good compatibility between the different components and also very good barrier properties. Outstanding properties result particularly when a blend of PVOH, modified PVOH, EVOH and modified EVOH is used.

In a further very advantageous embodiment of the present invention, the base plastic material is admixed with up to 50%, in particular up to 30%, preferably up to 10% of the additional plastic material.

This produces particularly good compatibility between the layer fabricated from the base plastic material and the next layer.

It is likewise very advantageous when the additional plastic material is admixed with up to 50% of base plastic material, in particular up to 30%, preferably up to 10%.

This produces particularly good compatibility between the layer fabricated from the additional plastic material and the layer fabricated from the base plastic material.

It has also proven extremely advantageous according to the present invention when a polymer, in particular a functionalized polymer is provided as adhesion promoter.

Functionalized polymers have predeterminable properties within wide limits.

In a further very advantageous development of the present invention, a polymer, in particular a polyethylene or polypropylene, modified by grafting is provided as adhesion promoter.

It has likewise proven very advantageous when an acrylate-based, in particular methacrylate-based adhesion promoter is provided.

In a further very advantageous embodiment of the present invention, an ethylene acrylate is provided as adhesion promoter.

All these adhesion promoters provide particularly good adherence and compatibility between the different materials.

It has further proven to be extremely advantageous when the adhesion promoters are modified with maleic anhydride or the like.

Adhesion promoters modified with maleic anhydride or the like have proven to be particularly useful for the plastics of the present invention.

It is further very advantageous when the adhesion promoter is blended with a further plastic material.

This likewise results in very good adherence and compatibility properties.

In a further extremely advantageous embodiment of the present invention, the adhesion promoter is blended with the base material and/or the barrier material.

The respective compatibility is still further improved as a result.

In accordance with a further embodiment of the present invention is has also proven very advantageous when the film is constructed of at least one film layer which has barrier properties with regard to gases, in particular with regard to oxygen.

This makes it possible to use the film of the present invention for packing goods sensitive to oxygen in particular.

It has also proven very advantageous according to the present invention when the film layer is constructed of the base material mixed with the additional plastic material.

This creates an intrinsic barrier to oxygen and the like.

But it is also very advantageous when the film is constructed of at least two film layers.

The further film layer may be a further film layer having different properties, or else constitute an additional barrier layer.

But it is also very advantageous according to the present invention when one layer is fabricated from the base material and the other from the additional plastic material.

This provides quite outstanding barrier properties.

It has also proven very advantageous according to the present invention when an adhesion promoter is provided between two successive film layers.

These adhesion promoters ensure that the film layers are bonded together particularly well.

It is also very advantageous according to the present invention when the individual film layers are modified.

Modification has the effect of altering the properties of the respective film layer in a defined manner.

It has proven very advantageous in this connection when the individual film layers are blended with the material of the next film layer.

This ensures particularly good compatibility between the successive film layers.

It has also proven extremely advantageous according to the present invention when the film is oriented.

This not only significantly reduces the thickness of the overall film but also alters the physical and/or chemical properties.

It has also proven very advantageous when the film is transparent.

It has also proven very advantageous when the film is opaque.

This makes the film of the present invention particularly useful for many packaging purposes.

It is also extremely advantageous according to the present invention when the barrier material is biodegradable.

This means that the biodegradability of the entire film is not adversely affected even when the barrier material accounts for comparatively large proportions.

An illustrative embodiment of the invention will now be more particularly described.

A base film consisting of PLA is extruded together with a PVOH or an EVOH which may have an ethylene content of 0.01 to 80 mol %. PLA, PVOH and EVOH are biodegradable.

PLA, moreover, is based on renewable raw materials.

The PLA can be in a mixture with PVOH or EVOH, or alternatively be coextruded in separate layers. In either case, a very good barrier effect with regard to oxygen in particular is obtained without the biodegradability of the PLA being adversely affected.

An adhesion promoter can be provided to enhance the coherence of the film assembly consisting of two or more layers and to eliminate any incompatibility between the individual layers.

But it is also conceivable to add an adhesion promoter or the like to a mixture of PLA and/or PVOH/EVOH in order that the compatibility between the components of the mixture may be improved.

Otherwise, certain, usually high mixing ratios can give rise to haze and inhomogeneities which can be avoided by using the additive material.

It is likewise conceivable to improve the compatibility of the actually incompatible materials by blending a small portion of one of such materials with the other material, so that also the adhesion of the individual layers to each other is enhanced. The small portion can be up to about 10%.

It is also conceivable for an adhesion promoter to be likewise admixed with at least one of the raw materials of the respectively adjoining layers. This again augments the performance of the adhesion promoter. Any minimal incompatibilities which arise are eliminated.

Useful adhesion promoters include all adhesion promoters compatible with the materials to be bonded together. Functionalized and nonfunctionalized polymers having the required properties can be provided in particular. Polymers such as for example PE or PP can be functionalized, by grafting for example, such that they can be used as adhesion promoters for the present invention.

It is conceivable to use particularly adhesion promoters based on ethylene, acrylate and methacrylate, which can be grafted with maleic anhydride for example.

Useful adhesion promoters include in particular ethylene-acrylate copolymers, ethylene-vinyl acetate, acid copolymers, polymers having acid anhydride functions, in particular polyethylene and polypropylene provided with unsaturated acid anhydrides, polymers and copolymers which contain hydroxyl groups, in particular polyvinyl alcohols, ethylene-containing polyvinyl alcohols, hydroxyethyl acrylate, ionomers or the like. These adhesion promoters can also be provided in the form of blends or batches with other materials.

The adhesion promoters functionalized with acid anhydride and/or hydroxyl groups are obtainable by copolymerization of, in particular, organic monomers with unsaturated acid anhydrides or hydroxyl-containing monomers, for example maleic acid anhydride, hydroxyethyl acrylate, hydroxypropyl acrylate or the like, or by grafting polymers with unsaturated acid anhydrides or hydroxyl-containing monomers.

These adhesion promoters, as already indicated above, can also be blended with the raw materials of the individual plastic layers, so that their performance as adhesion promoters is still further improved.

Useful raw materials for the base material include not only PLA but also further biodegradable plastic materials. Similarly, the barrier material can be other barrier materials which are suitable for the particular intended use and which should likewise be biodegradable.

The adhesion promoters used are preferably likewise biodegradable and can also be obtained from renewable raw materials.

The films produced by extrusion or coextrusion, in which case the cast and blown processes are possibilities, can subsequently be oriented to reduce their film thickness and also to alter their mechanical and optical properties.

Depending on the intended purpose of the film, orienting can be monoaxial and biaxial and at a variety of stretch ratios.

Similarly, the film can be brought together with further layers during extrusion or in the course of an aftertreatment.

It is conceivable in this connection that coatings can also be applied subsequently. It is in particular lacquers, in particular sealing or heat protection lacquers but also antifog additives, peel additives, antiblocking agents, optical brighteners, antistats, lubricants or plasticizers which can be applied, but also normal printing inks.

It is similarly conceivable to add antifog additives, peel additives, antiblocking agents, optical brighteners, antistats, lubricants, plasticizers and/or dyes to one of the plastic materials, i.e., to the base material and/or the barrier material and/or an additional plastic material. These additives can be introduced via masterbatch or via direct addition during extrusion, making it possible to achieve very homogeneous distribution.

It is similarly conceivable for the film layers of the present invention to be produced as monofilms and only to be joined together subsequently by laminating. A one- or multi-component laminating adhesive can then be employed for example.

The entire film, it is currently believed, can be fabricated of 2 to 12 individual layers, in which case monofilms or else multilayered assemblies having more layers by far are conceivable as well.

The thickness of the film assembly of the present invention is often between 5 and 5000 μm, but mostly between 20 and 2000 μm.

The films or film assemblies of the present invention are particularly useful for food packaging. They can be used to produce inter alia lid films but also thermo-formable bottom films.

Tests have shown that the barrier properties of the film of the present invention are highly developed.

To illuminate the test results, first a PLA monofilm having a thickness of 40 μm was produced in the blown process. This film has an oxygen permeation rate of 456 cubic centimeters per square meter per 24 h at 23° C. and 75% relative humidity.

The next step was to produce a monofilm consisting of three PLA layers, the individual layers of which have a thickness of 10 μm, 20 μm and 10 μm. This film has the same oxygen permeation rate as the monofilm described above.

### EXAMPLE 1

A 5 layer blown extruder was then used to produce a PLA-PVOH-PLA film having an overall thickness of again 40 μm. The first outside layer was a 10 μm PLA layer, followed by a 5 μm adhesion promoter layer. This was followed by a 10 μm PVOH layer, then another 5 μm adhesion promoter and, as the second outside layer, a 10 μm PLA layer. This film has an oxygen permeation rate of 58 cubic centimeters per square meter per 24 h at 23° C. and 75% relative humidity and therefore already has very good barrier properties with regard to oxygen.

### EXAMPLE 2

Example 1 was repeated using an EVOH layer instead of the PVOH layer. The oxygen permeation rate measured for this film was found to be 1.6 cubic centimeters per square meter per 24 h at 23° C. and 75% relative humidity. This film therefore has excellent barrier properties.

1. A method of producing a biodegradable plastic film or a film assembly having barrier properties, comprising producing the film or film assembly at least from a biodegradable base plastic material and a second plastic material having barrier properties.

2. The method according to claim 1, which comprises extrusion, and wherein the plastic materials are mixed before extrusion and then extruded together.

3. The method according to claim 2, wherein the plastic materials are mixed together before extrusion to form a masterbatch and are then extruded together with further base material.

4. The method according to claim 2, wherein the plastic materials are each extruded as film plies and conjoined.

5. The method according to claim 4, wherein the plastic materials are jointly coextruded.

6. The method according to claim 4, wherein the extruded film plies are finished with an adhesion promoter and conjoined with further film plies to form a multi-layered assembly.

7. The method according to claim 6, wherein the plastic film or the multilayered assembly is oriented.

8. The method according to claim 3, wherein a stabilizer is added to the masterbatch or mixture.

9. The method according to claim 3, wherein an adhesion promoter is added to the masterbatch or mixture.

10. The method according to claim 4, wherein an adhesion promoter is introduced between two film plies in each case.

11. The method according to claim 10, wherein the adhesion promoter is coextruded together with at least one of the two film plies.

12. The method according to claim 10, wherein the adhesion promoter is applied onto one of the film plies.

13. The method according to claim 1, wherein the base plastic material is admixed with a further plastic material to enhance the compatibility with the barrier material.

14. The method according to claim 13, wherein the base plastic material is mixed with a portion of the barrier material.

15. The method according to claim 1, wherein the barrier material is admixed with a further plastic material to enhance the compatibility with the base material.

16. The method according to claim 15, wherein the barrier material is mixed with a portion of the base plastic material.

17. The method according to claim 1, wherein the film is heat molded.

18. The method according to claim 1, wherein a biodegradable barrier material is used.

19. A biodegradable plastic film obtained by a method according to claim 1, which comprises a PLA (polylactide) as base plastic material.

20. The biodegradable plastic film according to claim 19, which comprises a polyvinyl alcohol (PVOH) as additional plastic material.

21. The biodegradable plastic film according to claim 20, which comprises a modified PVOH.

22. The biodegradable plastic film according to claim 19, which comprises an ethylene-containing vinyl alcohol (EVOH) additional plastic material.

23. The biodegradable plastic film according to claim 22, which comprises a modified EVOH.

24. The biodegradable plastic film according to claim 19, which comprises a further additive material having barrier properties.

25. The biodegradable plastic film according to claim 19, which is produced from a blend of PVOH, modified PVOH, EVOH, modified EVOH and/or further additive materials.

26. The biodegradable plastic film according to claim 19, wherein the base plastic material is admixed with up to 50% of the additional plastic material.

27. The biodegradable plastic film according to claim 19, wherein the additional plastic material is admixed with up to 50% of base plastic material.

28. The biodegradable plastic film according to claim 19, which comprises an adhesion promoting polymer.

29. The biodegradable plastic film according to claim 28, wherein the adhesion promoting polymer is a polyethylene or polypropylene, modified by grafting.

30. The biodegradable plastic film according to claim 28, wherein the adhesion promoting polymer is an acrylate-based adhesion promoter.

31. The biodegradable plastic film according to claim 30, wherein the adhesion promoting polymer is an ethylene acrylate adhesion promoter.

32. The biodegradable plastic film according to claim 19, wherein the adhesion promoters are modified with maleic anhydride or the like.

33. The biodegradable plastic film according to claim 28, wherein the adhesion promoter is blended with a further plastic material.

34. The biodegradable plastic film according to claim 33, wherein the adhesion promoter is blended with the base material and/or the barrier material.

35. The biodegradable plastic film according to claim 19, wherein the film is constructed of at least one film layer which has barrier properties with regard to gases.

36. The biodegradable plastic film according to claim 35, wherein the film layer is constructed of the base material mixed with the additional plastic material.

37. The biodegradable plastic film according to claim 35, wherein the film is constructed of at least two film layers.

38. The biodegradable plastic film according to claim 37, comprising one layer fabricated from the base material and another from the additional plastic material.

39. The biodegradable plastic film according claim 32, wherein an adhesion promoter is provided between two successive film layers.

40. The biodegradable plastic film according claim 32, wherein individual film layers are modified.

41. The biodegradable plastic film according to claim 40, wherein the individual film layers are blended with a material which is identical to a material of a next film layer.

42. The biodegradable plastic film according to claim 19, wherein the film is oriented.

43. The biodegradable plastic film according to claim 19, wherein the film is transparent.

44. The biodegradable plastic film according to claim 19, wherein the film is opaque.

45. The biodegradable plastic film according to claim 19, wherein the barrier material is biodegradable.

46. A method of packaging sensitive goods, comprising packaging the goods in a plastic film according to claim 19, wherein the film has barrier properties with regard to oxygen or the like, and contains nonmodified PLA.
